(19) United States
(12) Patent Application Publication
(10) Pub. No.: US 2008/0198180 A1
(43) Pub. Date: Aug. 21, 2008

(54) Method and Apparatus of Converting Signals for Driving Display and a Display Using the Same

(75) Inventor: Erno H.A. Langendijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,421

(22) PCT Filed: Jul. 4, 2006
(86) PCT No.: PCT/IB2006/052244

§ 371 Date: Jan. 2, 2008

(30) Foreign Application Priority Data
Jul. 5, 2005 (EP) 05106106.7

(51) Int. Cl. G09G 5/02

(52) U.S. Cl. 345/690

(57) ABSTRACT

A method, apparatus and computer program for driving displays including an array of display elements, each element comprising sub-pixels or red, green, blue and white colours, the method comprising steps of; receiving input signals for controlling red, green and blue colours of each element of the display; processing the input signals to generate corresponding red, green, blue and white output drive signals for the red, green, blue and white sub-pixels of each element, all input colours which are outside of the output gamut being mapped to within a predetermined area of the output gamut and all input colours within the predetermined area of the output gamut being mapped to another colour within the predetermined area of the output gamut; and applying the output drive signals to respective sub-pixels for each element of the display.

The present invention relates to methods, apparatus and computer program for driving displays comprising arrays of pixels.

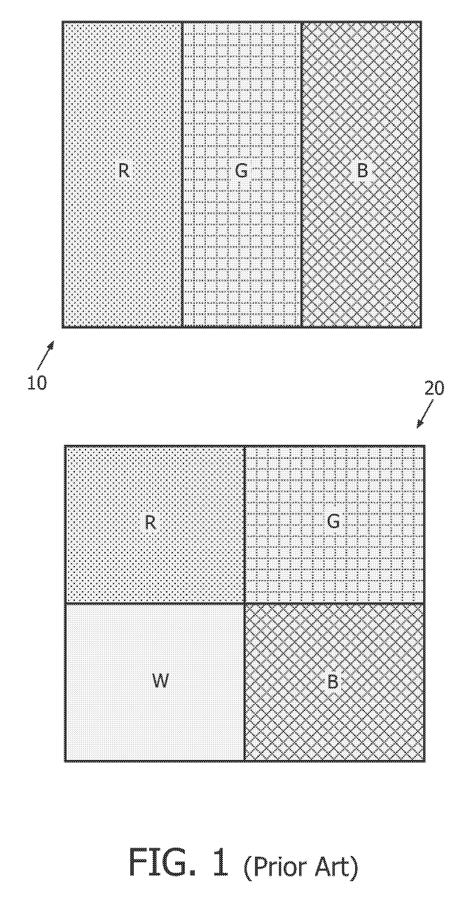

The most common form of pixellated colour display is currently the colour liquid crystal display (LCD). Colour LCDs typically comprise a two-dimensional array of display elements, each element including red (R), green (G) and blue (B) sub-pixels employing associated colour filters. The colour filters of each element absorb approximately ⅔ of the light passing through them. In order to increase optical transmittance, it is known practice in the art to add a white sub-pixel (W) to each element in a manner as depicted in FIG. 1 wherein a three-sub-pixel RGB element is indicated by 10, and a four-sub-pixel RGBW element including a white (W) sub-pixel is indicated by 20.

In the element 20, the red (R), green (G) and blue (B) sub-pixels each have an area which is 75% of that of a corresponding colour-sub-pixel included in the element 10. However, the white (W) sub-pixel of the element 20 does not include a colour filter and in operation is able to transmit an amount of light corresponding approximately to the sum of light transmissions through the red (R), green (G) and blue (B) sub-pixels of the element 20. Thus, the element 20 is capable of transmitting substantially 1.5 times more light than the element 10. Such enhanced transmission is of benefit in LCDs employed to implement television, in lap-top computers where increased display brightness is desired, in projection television (rear and front view, LCD and DLP), in lap-top computers where highly energy-efficient back-lit displays are desired to conserve power and thereby prolong useful battery life, and in LCD/DLP graphics projectors (beamers). However, introduction of the white (W) sub-pixel in to the element 10 to generate the element 20 introduces a technical problem regarding optimal drive to the R, G, B, W sub-pixels of each element 20 to provide optimal rendition of a colour image on the display.

Liquid crystal displays (LCDs) each comprising an array of elements, wherein each element includes red (R), green (G), blue (B) and white (W) sub-pixels, are described in US 2004/0046725. Moreover, the displays described also include gate lines for transmitting gate signals to their sub-pixels, and data lines for transmitting data signal to their sub-pixels. The displays described each further include a gate driver for supplying gate signals to the gate lines, a data driver for supplying data voltage to the data lines, and an image signal modifier. The image signal modifier includes a data converter for converting three-colour image signals into four-colour image signals, a data optimiser for optimising the four-colour image signals from the data converter, and a data output unit supplying the optimised image signals to the data driver in synchronisation with a clock.

Red-Green-Blue (RGB) space is a three-dimensional colour space whose components are the red, green, blue intensities that make up a given colour. RGB-based colour spaces are the most commonly used colour spaces in computer graphics, primarily because they are directly supported by most colour displays. The groups of colour spaces within the RGB base family include Hue-Lightness-Saturation (HLS) spaces and RGB spaces.

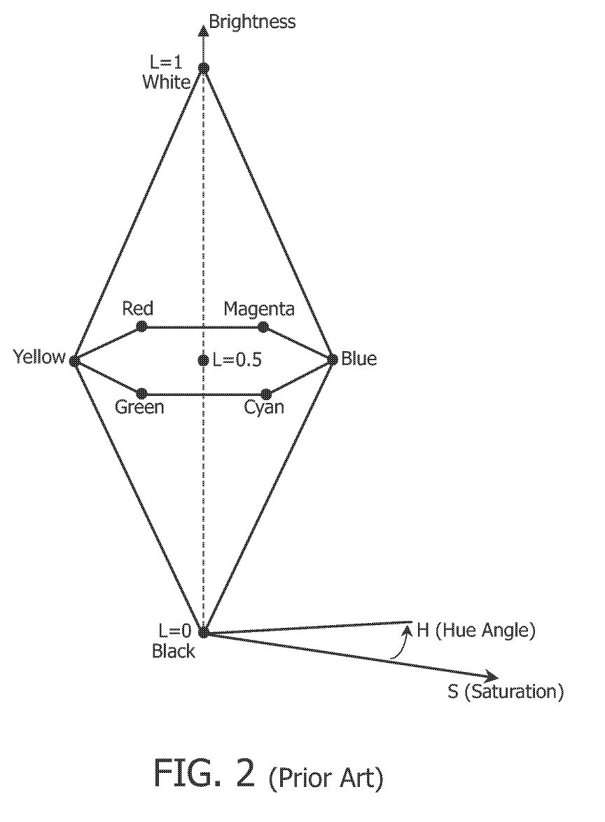

FIG. 2 is a diagram of an HLS space, which is a double hexcone. The colour components of an HLS space are hue, lightness and saturation. Hue is what is normally thought of as colour. Lightness is the amount of black or white in a colour (increasing lightness makes the colour brighter, decreasing lightness makes the colour darker). Saturation is a measure of the purity of a colour. As saturation is decreased, the colour becomes more grey, and a saturation value of zero results in a grey-scale value.

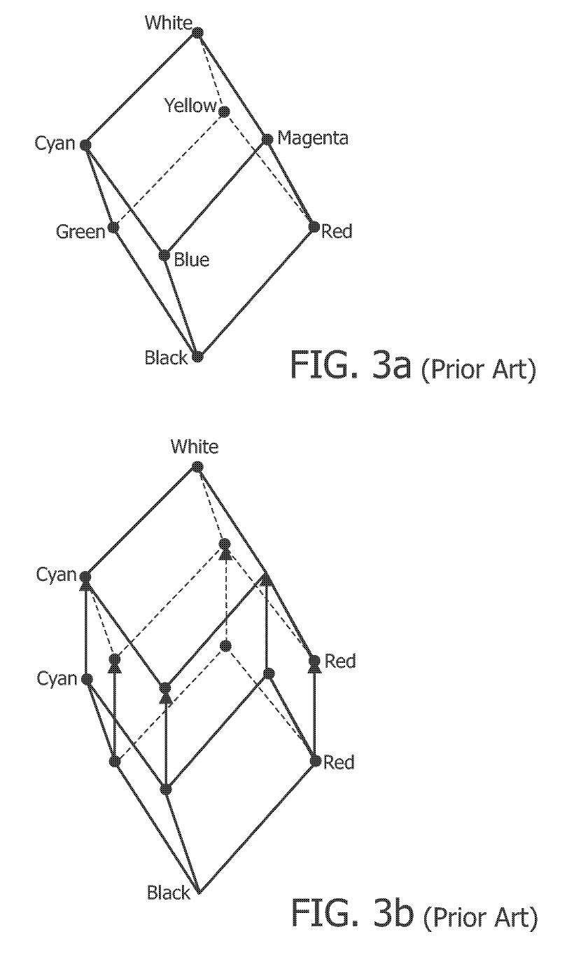

Mapping the colours red, green, and blue onto a 3-D Cartesian coordinate system creates an RGB colour space. This results in a 3-D cube, an example of which is shown in FIG. 3a. The origin of the coordinates system is black, where the RGB colour components are all zero. The diagonally opposite corner of the cube is white, where the RGB colour components are at their maximum value. The primary colours are red, green, and blue. The secondary colours are cyan, yellow, and magenta.

Introduction of the white (W) sub-pixel to generate the element 20 increases the brightness of the colour space. As a result, the RGB colour space is modified such that it extends in the lightness axis to produce an RGBW colour space as illustrated in FIG. 3b. It can therefore be appreciated that the range of colour available from an RGBW colour space is greater than that of an RGB colour space.

The range of colour that a given device can produce is known as the gamut. Thus, it is apparent that the colour gamut of an RGBW display with elements 20 is larger than the gamut of an RGB display with elements 10.

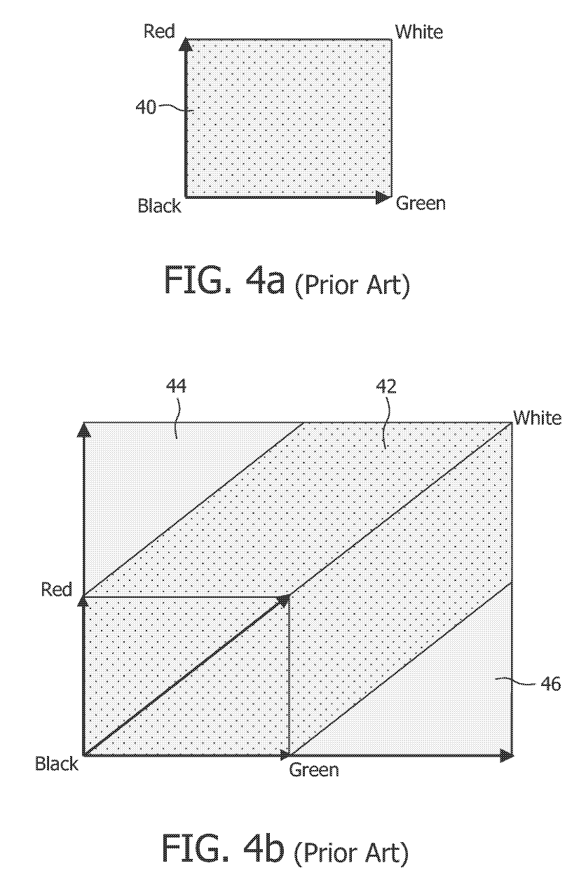

For convenience and improved clarity, it is convenient to work in 2-D colour space, and this is achieved by projection of the 3-D colour space onto a plane. FIGS. 4a and 4b are projections of the 3-D colour space illustrated in FIGS. 3a and 3b respectively, whereby the value of the blue component is constant. In the following description, it will be assumed that the output gamuts are normalised, so that the maximum dimension along the axes of FIG. 4a is 1 and the maximum dimension along the axes of FIG. 4b is 2.

The shaded areas illustrate the colour gamut of each space. If the RGB colour gamut is defined as the input gamut 40, and the RGBW colour gamut is defined as the output gamut 42, it can be appreciated that conversion of the RGB input into a RGBW output defines a range of possible outputs which is larger than the output gamut of the RGBW element 20. The output colours that cannot be produced by the RGBW display are outside of the RGBW colour gamut, within the empty areas 44,46. Hence, the inclusion of the white (W) sub-pixel in the element 20 means that there exists a range of colours that cannot be displayed by the RGBW element. In particular, high saturation colours (e.g. a rich red) cannot be displayed with high brightness.

The process of redefining the input colours of a given device so that its gamut becomes substantially equal to that of a second device is called ‘gamut mapping’, and it is gamut mapping that has become an important problem in colour management. The optimal gamut mapping approach for a given case depends on input and output device gamuts, image content, user intent and preference.

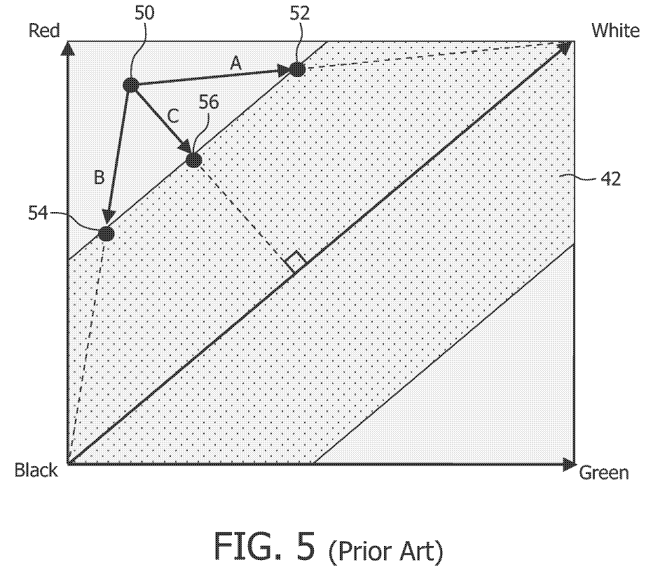

A number of approaches to pixel-wise gamut mapping from RGB to RGBW are known. Some of these gamut mapping methods will now be described with reference to FIG. 5 which illustrates pixel mappings to the 2-D RGBW colour output gamut of FIG. 4b

A first known scheme, which will be termed ‘hard-clip to white’, comprises mapping all colours outside of the output gamut using a mapping criterion of scaling the colour towards the value of white, where the colour components are at their maximum value. For example, an outside gamut colour 50 is projected onto the output gamut in the direction indicated by arrow A. The outside gamut colour 50 is thereby mapped to a colour 52 within the output gamut 42. Recalling that saturation is a measure of the purity of a colour, and that as saturation is decreased the colour becomes more grey, it can be appreciated that the ‘hard-clip to white’ results in an output colour 52 which has decreased saturation and increased luminance when compared to the outside gamut colour 50.

A second known scheme, which will be termed ‘hard-clip to black’, comprises mapping all colours outside of the output gamut using a mapping criterion of scaling the colour towards the value of black, where the colour components have zero value. For example, an outside gamut colour 50 is projected onto the output gamut in the direction indicated by arrow B. The outside gamut colour 50 is thereby mapped to a colour 54 within the output gamut 42. It can be appreciated that the ‘hard-clip to black’ results in an output colour 54 which has decreased saturation and decreased luminance when compared to the outside gamut colour 50.

A third known scheme, which will be termed ‘equal luminance hard-clip’, comprises mapping all colours outside of the output gamut using a mapping criterion of reducing the saturation directly towards the grey-scale axis. For example, an outside gamut colour 50 is projected onto the output gamut in the direction indicated by arrow C. The outside gamut colour 50 is thereby mapped to a colour 56 within the output gamut 42. It can be appreciated that the ‘equal luminance hard-clip’ results in an output colour 56 which has decreased saturation when compared to the outside gamut colour 50.

It may be appreciated that the ‘hard-clip’ mapping schemes result in an abrupt change in colour rendition for colours outside of the output gamut while colours within the output gamut are unchanged. Furthermore, the ‘hard-clip’ schemes do not account for the natural perception of colours whereby saturated colours appear less bright than unsaturated colours. Thus, the ‘hard-clip’ schemes result in an output RGBW signal with a disturbed brightness and colour balance making natural images look worse on RGBW displays.

Another important problem of the “hard-clip” mapping is that, for example, all colours on the line A are mapped to one output colour (52). This will cause a loss of detail in the image (usually referred to as clipping artefacts) when these pixels with these colours are close to each other.

It has therefore been demonstrated that the requirement of converting RGB signals into RGBW signals to obtain an optimal compromise between enhanced brightness and the best colour rendition remains an area of difficulty.

According to a first aspect of the invention, there is provided a method of driving a display including an array of display elements, each element comprising sub-pixels of red, green, blue and white colours, the method comprising steps of;

(i) receiving input signals for controlling red, green and blue colours of each element of the display;

(ii) processing the input signals to generate corresponding red, green, blue and white output drive signals for the red, green, blue and white sub-pixels of each element, all input colours which are outside of the output gamut being mapped to within a predetermined area of the output gamut and all input colours within the predetermined area of the output gamut being mapped to another colour within the predetermined area of the output gamut; and

(iii) applying the output drive signals to respective sub-pixels for each element of the display.

This method scales a colour point which is outside the possible output gamut back into a region which is within the output gamut. Furthermore, a region of the output gamut near to the outer boundary is also scaled so that a more natural range of output colours results.

In step (ii), the mapping of input colours which are outside of the output gamut or within the predetermined area of the output gamut can be a linear translation towards the zero colour value of black, or a more complex function. The magnitude of a linear scaling can be proportional to the distance of the colour from a boundary of the predetermined area of the output gamut.

The mapping of input colours may further comprise subtracting a value from the red, green and blue output drive signals of the colour being mapped and adding a value to the white output drive signal of the colour being mapped. This can then change the colour balance, rather than simply scaling to black.

The invention also provides an apparatus for driving a display including an array of display elements, each element comprising sub-pixels of red, blue, green and white colours, said apparatus comprising processing means operable:

to receive input signals for controlling red, green, and blue colours of each element of the display;

to process the input signals to generate corresponding red, green, blue and white output drive signals for the red, green, blue and white sub-pixels of each element, all input colours which are outside of the output gamut being mapped to within a predetermined area of the output gamut and all input colours within the predetermined area of the output gamut being mapped to another colour within the predetermined area of the output gamut; and

to apply the output drive signals to respective sub-pixels for each element of the display.

Embodiments of the invention will now be described, by way of example only, with reference to the following diagrams wherein:

FIG. 1 is a schematic illustration of an element of a pixel display, one implementation of the element including red (R), green (G) and blue (B) sub-pixels only, in contradistinction to another implementation of the element including red (R), green (G), blue (B) and white (W) sub-pixels;

FIG. 2 is a diagram of a Hue-Lightness-Saturation (HLS) space; and

FIG. 3 is an illustration of a) a 3-D RGB colour space and b) a 3-D RGWB colour space;

FIG. 4 is an illustration of 2-D RGB and RGBW colour spaces projected from the 3-D colour space illustrated in FIGS. 3a and 3b respectively, whereby the value of the blue component is constant;

FIG. 5 is an illustration of ‘hard-clip’ pixel mapping schemes within the 2-D RGBW colour output gamut of FIG. 4b;

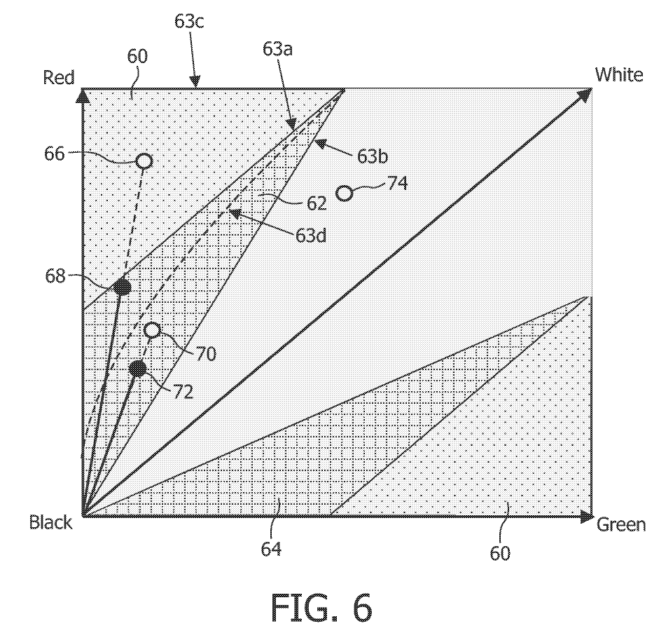

FIG. 6 is an illustration of a ‘soft-clip’ pixel-mapping scheme within the 2-D RGBW colour output gamut of FIG. 4b according to an example of the present invention;

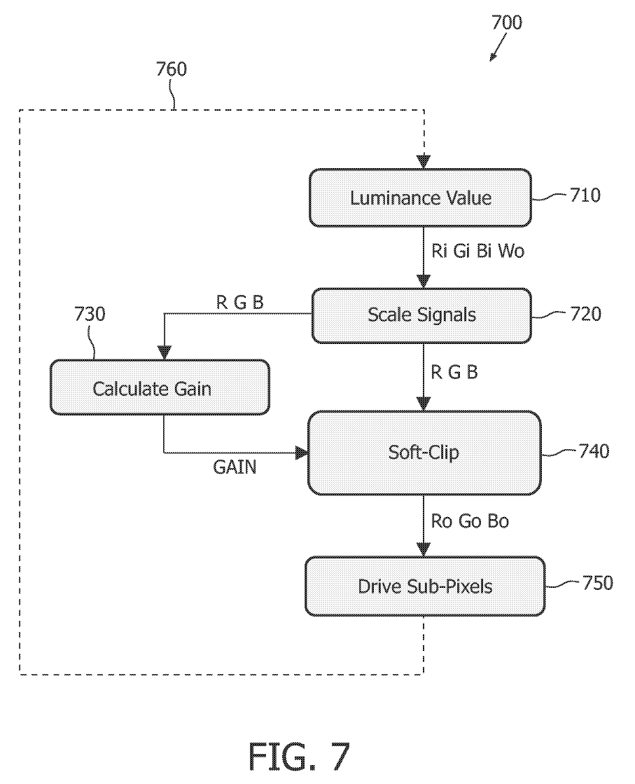

FIG. 7 is a schematic diagram of processing steps executed in a ‘soft-clip’ pixel-mapping scheme according to an example of the present invention;

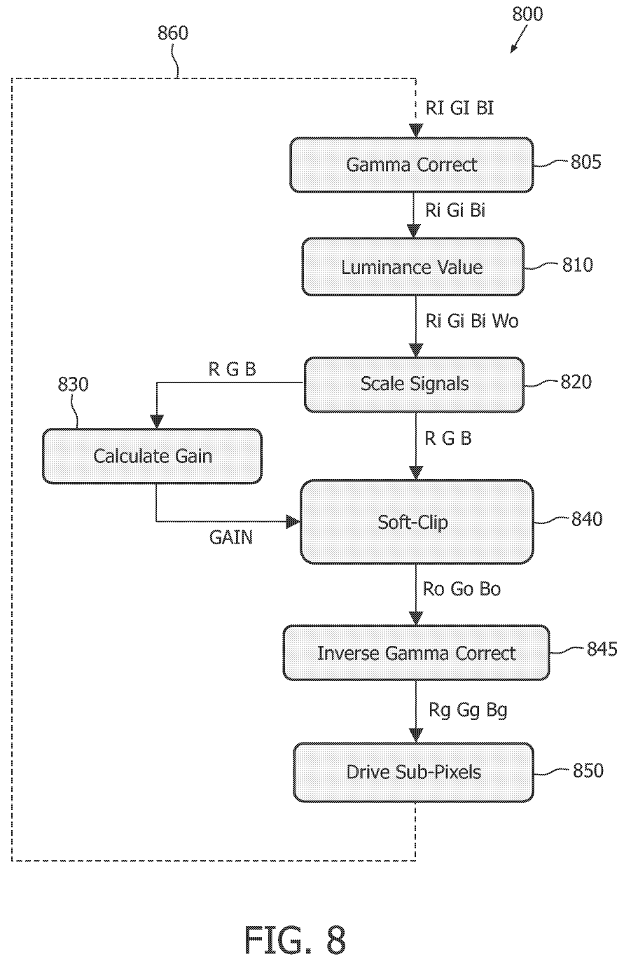

FIG. 8 is a schematic diagram of processing steps executed in a ‘soft-clip’ pixel-mapping scheme according to another example of the present invention;

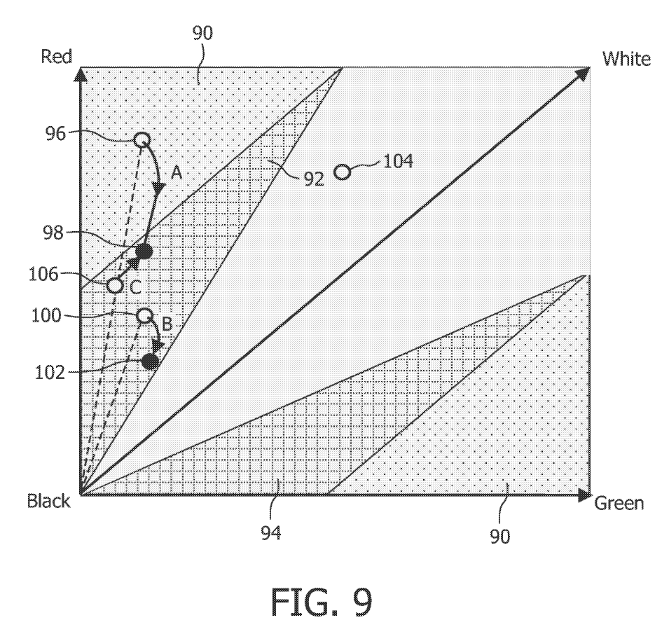

FIG. 9 is illustration of a ‘soft-clip with combined luminance-adjustment’ pixel-mapping scheme within the 2-D RGBW colour output gamut of FIG. 4b according to a preferred example of the present invention; and

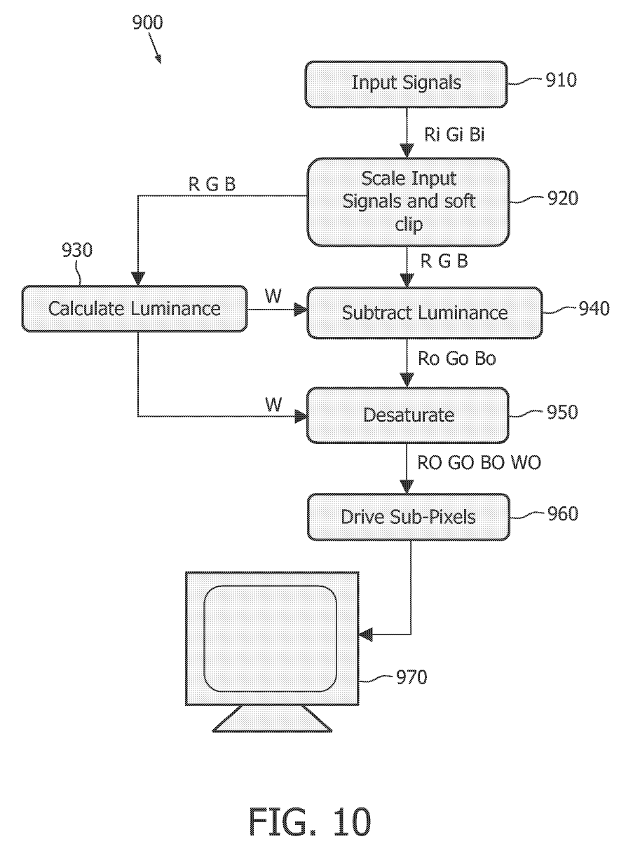

FIG. 10 is schematic diagram of processing steps executed in a ‘soft-clip with combined luminance-adjustment’ pixel-mapping scheme according to a preferred example of the present invention.

The gamut mapping methods described above can generate unacceptable colour hues to images presented using a RGBW display. The invention provides a method of gamut mapping an RGB input, (comprising input signals Ri, Gi, Bi for red, green, blue colours respectively) to an RGBW output (comprising output signals Ro, Go, Bo, Wo for driving red, green, blue, white sub-pixels respectively), wherein the method utilises an algorithm which can be described as a “soft clip” algorithm. The soft clip algorithm attempts to provide an RGBW output with enhanced brightness while providing the best colour rendition of the RGB input.

An example of the soft-clip algorithm will now be described with reference to FIG. 6.

The soft clip algorithm comprises mapping all saturated input colours (those that occur in the area 60 outside of the output gamut) to within the output gamut and compressing all colours within predetermined areas 62,64 of the output gamut using a compression criterion. In this example, the predetermined areas 62,64 of the output gamut are defined by the boundaries of the output gamut and the lines R=2G and G=2R.

For example, an outside gamut colour 66 is projected onto the output gamut, thereby mapping it to a colour 68 within the output gamut. Also, a colour 70 within the predetermined area 62 of the output gamut is compressed further into the output gamut. The inside gamut colour 70 is thereby mapped to a colour 72 within the output gamut. Finally, a colour 74 within the output gamut and not within the predetermined areas 62,64 is not modified.

It can be appreciated that the soft clip method results in the output colours 68,72 which have decreased saturation and decreased luminance when compared to the input gamut colours 66,70. However, the reduction in saturation and luminance is such that there is not an abrupt change in colour rendition.

It can therefore be appreciated that the soft clip method of the present invention provides improved gamut mapping by maintaining the brightness balance between colours, unlike the hard-clip schemes.

The method of the present example will now be further explained with reference to FIG. 7 wherein the steps of the method are indicated generally by 700.

In step 710, a luminance value (Wo) for the white (W) sub-pixel is calculated using the input signals Ri, Gi, Bi as described by Equation 1 (Eq. 1):

Wo=min(Ri,Gi,Bi) (Eq.1)

wherein min(Ri, Gi, Bi) returns a value corresponding to a minimum value of arguments Ri, Gi and Bi.

In step 720, the luminance value (Wo) is subtracted from scaled input signals Ri, Gi, Bi, thus computing scaled intermediate signals R, G, B as described by Equations 2 (Eqs. 2):

R=(2*Ri)−Wo

G=(2*Gi)−Wo

B=(2*Bi)−Wo (Eqs. 2)

wherein the scale factor, defined with the value of two for this specific example (to provide mapping to the 2×2 size output RGBW space), may be a different specific value.

In step 730, a gain factor (GAIN) is calculated from the intermediate signals R, G, B, as described by Equation 3a (Eq. 3a):

GAIN=f(R,G,B) (Eq. 3a)

Typically, this function will take into account a maximum value of the R, G, B values:

GAIN=f(max(R,G,B)) (Eq. 3b)

wherein max(R, G, B) returns a value corresponding to a maximum value of arguments R, G, and B.

In step 740, the intermediate input signals R, G, B are multiplied by the value of GAIN, as described by Equations 4a (Eqs. 4a):

Ro=GAIN*R;

Go=GAIN*G;

Bo=GAIN*B; (Eqs. 4a)

The gain values used in Equations 4a are selected to compress all input colours that are outside of the input gamut or within the predetermined areas 62,64 of the output gamut. Since the gain is the same for each colour component, the scaling is a linear translation towards the zero colour value of black.

In step 750, the values of R, G, B and Wo are output for driving the red, green, blue and white sub-pixels respectively.

Step 710 to 750 are performed for each element 20 in each frame present on the display. In step 760, the method the loops back to refresh sub-pixels of the display element 20 for a subsequent image frame.

The function used to determine the gain value can take many different forms. Essentially, the function must translate all colours outside the output gamut to a location within the output gamut, and must also perform soft clipping by additionally translating colours near to that output boundary line (or plane in 3D). Colours far inside the boundary line (or plane) can be left unaltered.

The function can be based on the amount by which a colour extends outside the output gamut defined by the boundary 63a, or based on a distance from the inner boundary 63b between area 62 and the white area in FIG. 6. FIG. 6 also shows the outer boundary 63c of the possible output values, which is outside the output gamut.

Instead of scaling to black, the scaling can be independently calculated for each colour component. In general terms:

RGAIN=f_{R}(R,G,B)

GGAIN=f_{G}(R,G,B)

BGAIN=f_{B}(R,G,B) (Eqs. 4b)

In step 740, the intermediate input signals R, G, B are multiplied by the respective gain factors, as described by Equations 5 (Eqs. 5):

Ro=RGAIN*R;

Go=GGAIN*G;

Bo=BGAIN*B; (Eqs. 5)

The gain functions are selected to compress all input colours that are outside of the input gamut or within the predetermined areas 62,64 of the output gamut using a non-linear translation.

It may be appreciated that Equations 3 and 4 may be defined such that the gain factor(s) and multiplication(s) are of any suitable value, for example, as mentioned above, the value of each GAIN factor may be dependant upon a distance of the input colour from the inner boundary 63b or outer boundary 63a of the predetermined areas 62,64 of the output gamut. Manipulation of these equations will simply result in different distributions of compressed values within the predetermined areas 62,64 of the output gamut.

In one example, the gain functions are selected to compress the boundary 63c to the boundary 63a, and to compress the boundary 63a towards the boundary 63b. This gives a smooth range of compressed values. The amount of compression may be a function of a power of the distance of the input value from the boundary 63a or 63b.

The boundary 63a is compressed to an intermediate boundary 63d.

In its simplest form, the scaling may simply be a linear scaling to black which maps the line 63c to 63a. Any input value is scaled according to the scaling value for the part of the boundary 63c to which the colour vector points. For example, for the value R=2, G=0 in FIG. 6, GAIN=0.5, whereas for the value R=2, G=1, GAIN=1. Other points along the boundary 63c have other GAIN values. The GAIN value for the intermediate points along the boundary 63c is between these values.

However, two functions may instead be used:

F1: GAIN=f(dⁿ, v), where d=distance by which the input colour is outside the boundary 63a along a vector from the origin, and v is the input vector.

The GAIN value provided by this function is applied to all input values in region 60. The effect of this is to compress boundary 63c to 63a, and to provide weighting of output values nearer to the boundary 63a rather than distributed evenly. For example, if n=½, the region 60 is compressed close to the boundary 63a. Instead of using a distance measurement, a different value may be used based on a combination of minimum and maximum colour values, but which in some way represents a level of overshoot of the output colour outside the output gamut.

F2: GAIN=f(d′, v), where d′=distance by which the input colour is inside the boundary 63a along a vector from the origin. The GAIN value provided by this function is applied to all input values in region 62. The effect of this is to compress boundary 63a to the same location as the result of function F1 applied to boundary 63a.

Thus, the boundary 63a is compressed to the intermediate boundary 63d by both functions F1 and F2. This provides a smooth transition. There is linear compression of the values within region 62 towards the boundary 63b. The function is chosen to map boundary 63b to itself.

The two functions are thus interrelated to give a smooth complete function. This results in the region 60 being compressed into a region close to the boundary 63a, and with less compression for values within the region 62. This may provide improved colour rendition compared to a more simply single linear scaling function as explained above. In particular, the effect on colours near the boundary 63b can be much less than the effect on colours near the boundary 63a, and this can be achieved using power (or root) functions.

Numerous other functions are possible. Furthermore, the boundary 63b may not be a linear relationship between colours as shown and does not need to extend to the origin. The functions may be implemented using the minimum and maximum colour values of the input, as these two values dictate how the input colour extends outside the output gamut, and can therefore be used to represent the boundary 63a.

In summary, in executing steps 710 to 760, an input RGB signal is converted to an output RGBW signal by subtracting a calculated luminance value for the white sub-pixel (W) from a scaled RGB input signal. The result is then mapped so that the gamut of the input signals substantially matches the gamut of the output signals. The gamut mapping is completed using ‘soft clipping’ comprising mapping all saturated values (those that occur outside of a predetermined area of the output gamut) to within the output gamut using a mapping criterion, the mapping criterion reducing colour saturation and colour luminance of the saturated values.

It will be appreciated to those skilled in the art that the input signals Ri, Gi, Bi are subject to a gamma characteristic of the display when driving the display. This gamma characteristic concerns a relationship between the drive signal applied to the display and a corresponding optical effect achieved in the display. Moreover, the gamma characteristic is often a non-linear function. It is beneficial to pre-compensate the input signals Ri, Gi, Bi used to drive the element 20 to account for gamma. However, when determining transmissions of light through the R, G, B and W sub-pixels of the element 20, it is convenient to work with parameters having a linear relation to light transmission through the element 20, namely in a “linear light domain”.

Accordingly, an alternative example that takes account of the gamma characteristics will now be further explained with reference to FIG. 8 wherein the steps of the method are indicated generally by 800. The method only differs from that indicated by 700 in that it further comprises steps 805 and 845.

In step 805, input signals RI, GI, BI are subject to gamma correction converting them from the gamma-domain to linear domain as described by Equations 6a (Eqs. 6a):

Ri=(RI)^{γ}

Gi=(GI)^{γ}

Bi=(BI)^{γ} (Eqs. 6a)

wherein Ri, Gi, Bi denote linear domain input signals equivalent to the corresponding gamma domain signals RI, GI, BI respectively.

In step 845, the output signals R, G, B are converted back to the gamma domain for use on a display as described by Equations 6b (Eqs. 6b):

Rg=(Ro)^{1/γ}

Gg=(Go)^{1/γ}

Bg=(Bo)^{1/γ} (Eqs. 6b)

wherein Rg, Gg, Bg denote gamma domain signals equivalent to the corresponding linear domain output signals Ro, Go, Bo respectively.

Thus, in step 850, the values of Rg, Gg, Bg and Wo are output for driving the red, green, blue and white sub-pixels of the element 20 respectively. The other steps are the same as previously described above and have therefore not been described in detail again.

A further example of the soft-clip algorithm will now be described with reference to FIG. 9.

Again, the soft clip algorithm comprises mapping all saturated colours (those that occur in the area 90 outside of the output gamut) to within predetermined areas 92,94 of the output gamut and compressing all colours within predetermined areas 92,94 of the output gamut. The predetermined areas 92,94 of the output gamut are again in this example defined by the boundaries of the output gamut and the lines R=2G and G=2R.

An outside gamut colour 96 is mapped onto the output gamut in a direction indicated by arrow A. The outside gamut colour 96 is thereby mapped to a colour 98 within the output gamut. Also, a colour 100 within the predetermined area 102 of the output gamut is compressed further into the output gamut in a direction indicated by arrow B. The inside gamut colour 100 is thereby mapped to a colour 102 within the output gamut. This soft-clip algorithm comprises luminance-adjustment. In other words, the colour is not linearly scaled to black, instead the scaling path also includes movement along/parallel to the grey-scale axis.

As with the soft-clip algorithms detailed earlier, a colour 104 within the output gamut and not within the predetermined areas 92,94 is not modified.

It can be appreciated that the method of this example is similar to those indicated generally by 700 and 800 and comprises the further step of luminance-adjusting the compressed output signals Ro, Go, Bo to provide modified output signals RO, GO, BO.

An example of this ‘soft-clip with combined luminance-adjustment’ method will now be further explained with reference to FIG. 10, wherein the steps of the method are indicated generally by 900.

The input signals Ri, Gi, Bi are provided at step 910.

In step 920, the input signals Ri, Gi, Bi are scaled, thus computing intermediate signals R, G, B as described by Equations 7 (Eqs. 7):

MAX=max(Ri,Gi,Bi)

Gain=f(MAX)

R=Gain*Ri

G=Gain*Gi

B=Gain*Bi (Eqs. 7)

wherein max(Ri, Gi, Bi) returns a value corresponding to a maximum value of arguments Ri, Gi, and Bi.

In this example, the “soft clipping” as explained above, is implemented as part of the scaling operation, and before extraction of the W value. This difference is simply to illustrate that the mapping function can be conceptualised in different orders.

In step 930, a luminance value (W) is calculated using the intermediate signals R, G, B as described by Equation 8 (Eq. 8):

W=min(R,G,B) (Eq. 8)

wherein min(R, G, B) returns a value corresponding to a minimum value of arguments R, G, and B.

In step 940, the luminance value (W) is subtracted from the intermediate signals R, G, B, thus computing adjusted signals Ro, Go, and Bo. Thus, steps 920 and 930 scale the gamut of the input signals such that it substantially matches the gamut of the output, using the soft-clipping approach explained above. All input colours that are outside of the output gamut or within the predetermined areas of the output gamut can be scaled using a linear translation towards black, thus using a common gain value for each colour. As before, these equations may of any suitable form such that the gamut mapping objective is completed.

In step 950 the value of the signals Ro, Go, Bo, and W are modified to produce output signals RO, GO, BO and WO as described by Equations 9 (Eqs. 9):

$$SCALE = \frac{max ( 0 , MAX - 1 )}{MAX} \\ RO \{ \begin{matrix}( 1 - SCALE ) \times RO & MAX > 1 , \\ Ro & MAX \leq 1\end{matrix} \\ GO \{ \begin{matrix}( 1 - SCALE ) \times GO & MAX > 1 , \\ Go & MAX \leq 1\end{matrix} \\ BO \{ \begin{matrix}( 1 - SCALE ) \times BO & MAX > 1 , \\ Bo & MAX \leq 1\end{matrix} \\ WO = W + [ \begin{matrix}α ( SCALE \times Ro ) + \\ β ( SCALE \times Go ) + \\ δ ( SCALE \times Bo )\end{matrix} ] \qquad ( Eqs . 9 )$$

wherein the value of MAX corresponds to a maximum value of the signals Ro, Go and Bo, and α, β, and δ are scalar values of any suitable value.

For example, if red has the maximum value of Ro,Go,Bo, Ro is at most MAX and:

Ro—SCALE×Ro=MAX−[M1×MAX]=MAX−(MAX−1)=1

Thus, if MAX>1 it is scaled to 1. The other values (Go and Bo, in this example) are scaled accordingly.

Equations 9, therefore, calculate a necessary scaling value that is subtracted from the signals Ro, Go, and Bo, and this represents a first movement of the colour output, giving new signals RO, GO, BO. A component is then added to the luminance value W to produce WO. These two operations effectively provide an operation which can be considered as a desaturation (compared to the soft clip to black described above), and this luminance adjustment improves the natural colour rendition for the human eye.

The value of SCALE is such that if one of Ro, Go, or Bo is larger than 1 it is scaled to 1 and the same SCALE value is used to increase the driving level for W. Since the scale on Ro, Go, and Bo preserves saturation (and hue) the increase of W increases the brightness, but decreases the saturation.

The value added to create WO takes account of the natural perception of colours, and this is how the values of α, β, δ, are selected. By way of example, α=0.2125, β=0.7154, δ=0.0721. The effect of these three components adding to 1 is that the total subtracted components (Equations 9) is equal to the total added luminance. Thus, the combined effect is a change in colour balance giving increased luminance, and this counters the reduction in luminance caused by the soft clip towards black, and to an extent which maintains a desired natural balance.

The end result can be described as a soft clip method, but which is not constrained to transform the output colour towards black or towards the greyscale axis, but instead transforms the output colour in a direction between the two. The scaling is no longer linear, but is dependent on the three colour components.

As will be apparent from the description above, an alternative way to achieve the same objective is to use gain values which are independently selected (Equations 4b above).

In step 960, the values of RO, GO, BO and WO are output for driving the red, green, blue and white sub-pixels of the element 20 respectively. A display 970 comprising an array of pixels (elements 20) is shown schematically in FIG. 10 and the invention provides a display 970 driven using the method described above.

This ‘soft-clip with luminance-adjustment’ method does not just compress all input colours that are outside of the output gamut or within the predetermined areas of the output gamut linearly towards black. Instead, the method also makes a calculated adjustment of the output colour value such that it is has an increased luminance which attempts to balance the natural brightness between colours.

It can be appreciated that this ‘soft-clip with combined luminance-adjustment’ method results in the output colours 98,102 having decreased saturation and decreased luminance when compared to the input gamut colours 96,100. However, when compared to the output 106 that is resultant from simply scaling to black, the output colour 98 has increased in luminance along the path indicated by arrow C.

The method therefore uses non-linear mappings which attempt to maintain the natural brightness and colour balance, the resultant mappings being similar to those illustrated by arrows A and B.

Explanation of how the balance is maintained comes from the realisation that saturated colours in nature are typically less bright than unsaturated colours. A reduction in saturation results in a corresponding increase in brightness and vice-versa. Thus, by optimising the colourfulness, the product of brightness and saturation, the natural brightness between colours may be balanced.

The way the invention improves the output can be understood further from a more detailed analysis of the problems with previous approaches.

The ‘equal luminance hard-clip’ method, comprising reduction of the saturation directly towards the grey-scale axis, maintains the luminance value while the saturation is decreased. Because the luminance is maintained in combination with a reduction in saturation, there is a perceived unnatural increase in brightness, thereby disturbing the natural colour balance.

Similarly, the ‘hard-clip to black’ method, comprising reduction of the saturation directly towards the value of black, decreases the saturation and luminance values. This reduction in luminance does not balance the natural increase in brightness, thereby disturbing the natural colour balance once again.

A similar consequence results from using the ‘hard-clip to white’ method. In this method the increase in luminance adds to the natural increase in brightness, again disturbing natural colour balance.]

An alternative example may further include the steps to take account of the gamma characteristics as explained earlier.

It can therefore be appreciated that the ‘soft-clip with luminance-adjustment’ method of the present invention provides further improved gamut mapping by maintaining the brightness balance between colours.

In the examples above, the predetermined areas of the output gamut are defined by the boundaries of the output gamut and the lines R=2G and G=2R (with similar relationships for full 3D colour space). This relationship is purely by way of example, and the mapping may use different portions of the output gamut.

The compression algorithm has been explained as a number of conceptual steps. In practice there will simply be a software-implemented complex function which implements the desired compression technique, and the design and implementation of the invention does not therefore need to be structured in the manner described above. This is for the purposes of explanation only.

The present invention is not limited to liquid crystal display (LCDs) but is also applicable to driving micro-mirror arrays employed for projecting images; such arrays are referred to a digital micromirror devices (DMDs).

The invention is also applicable to displays fabricated from arrays of elements wherein each element is individually addressable and comprises light emitting diodes of red, blue, green and white colours. In another related example, the invention is applicable to displays fabricated from arrays of elements implemented with vertical-cavity surface-emitting lasers (VCSELs) which are optionally individually addressable. Moreover, the present invention is also capable of being implemented in conjunction with organic LED (OLED) displays.

It should be noted that the above-mentioned embodiments are presented purely by way of example and that numerous modifications and alterations may be realised by those skilled in the art while retaining the teachings of the invention.

1. A method of driving a display including an array of display elements, each element comprising sub-pixels or red (R), green (G), blue (B) and white (W) colours, the method comprising steps of;
(i) receiving input signals (Ri, Gi, Bi) for controlling red, green and blue colours of each element of the display;
(ii) processing the input signals to generate corresponding red (Ro), green (Go), blue (Bo) and white (Wo) output drive signals for the red, green, blue and white sub-pixels of each element, all input colours which are outside (60) of the output gamut being mapped to within a predetermined area (62) of the output gamut and all input colours within the predetermined area (62) of the output gamut being mapped to another colour within the predetermined area (62) of the output gamut; and
(iii) applying the output drive signals to respective sub-pixels for each element of the display.

2. A method as claimed in claim 1, wherein in step (ii), the mapping of input colours which are outside (60) of the output gamut to within a predetermined area (62) of the output gamut is performed using a first relationship, and the mapping of all input colours within the predetermined area (62) of the output gamut to another colour within the predetermined area (62) of the output gamut is performed using a second relationship.

3. A method as claimed in claim 2, wherein the first relationship is based on a power of a value derived linearly from the input signal colour values (R,G,B).

4. A method as claimed in claim 2, wherein the first relationship maps an outer boundary (63c) of the possible output drive signal values to an outer boundary (63a) of the output gamut.

5. A method as claimed in claim 4, wherein the first relationship maps an outer boundary (63a) of the output gamut to an intermediate boundary (63d) within the output gamut.

6. A method as claimed in claim 5, wherein the second relationship maps an outer boundary (63a) of the output gamut to the intermediate boundary (63d) within the output gamut.

7. A method as claimed in claim 1, further comprising, after the step of processing, subtracting (950) a value from the red, green and blue output drive signals (Ro, Go, Bo) of the colour being mapped and adding a value to the white output drive signal of the colour being mapped.

8. A method as claimed in claim 1, further comprising converting (805) the input signals from a gamma domain to a linear domain for processing in step (ii) and converting (845) the output drive signals from the linear domain to the gamma domain for driving the sub-pixels of each element.

9. A method as claimed in claim 1, said method being adapted to process the input signals for driving at least one of:
a liquid crystal display;
a digital micromirror device; and
a display fabricated from arrays of elements wherein each element is individually addressable and comprises light emitting elements of red, blue, green and white colours.

10. An apparatus for driving a display including an array of display elements, each element comprising sub-pixels of red, blue, green and white colours, said apparatus comprising processing means operable:
to receive input signals (Ri, Gi, Bi) for controlling red, green, and blue colours of each element of the display;
to process the input signals to generate corresponding red, green, blue and white output drive signals (Ro, Go, Bo, Wo) for the red, green, blue and white sub-pixels of each element, all input colours which are outside of the output gamut being mapped to within a predetermined area (62) of the output gamut and all input colours within the predetermined area (62) of the output gamut being mapped to another colour within the predetermined area (62) of the output gamut; and
to apply the output drive signals to respective sub-pixels for each element of the display (970).

11. An apparatus as claimed in claim 10, wherein the display is implemented a liquid crystal display, a digital micromirror device or a display fabricated from arrays of elements wherein each element is individually addressable and comprises light emitting elements of red, blue, green and white colours.

12. A computer program comprising computer code means adapted to perform all the steps of claim 1 when said program is run on a computer.

13. A computer program as claimed in claim 12 embodied on a computer readable medium.

14. A display device comprising an array of pixels and an apparatus as claimed in claim 10 for driving the display pixels.
